(19) United States
(12) Patent Application Publication
(10) Pub. No.: US 2012/0012212 A1
(43) Pub. Date: Jan. 19, 2012

(54) FLO-NO-MO

(76) Inventors: Thomas Evan Daniell, Fort Myers, FL (US); Brian Thomas Alexander, Fort Myers, FL (US)

(21) Appl. No.: 12/858,339

(22) Filed: Aug. 17, 2010

Related U.S. Application Data
(60) Provisional application No. 61/365,176, filed on Jul. 16, 2010.

(51) Int. Cl. F16K 31/48

(52) U.S. Cl. 137/624.11

(57) ABSTRACT

The invention is a system named FLO-NO-MO. FLO-NO-MO prevents waste of water associated with toilets which do not properly retain their supply water as is common when a flapper does not seal properly or another toilet component fails. This is accomplished by integrating a mechanical style water supply timer at the point of water supply entry in a toilet tank and interconnecting the mechanical style water supply timer to a custom-made flush handle. The water supply valve in a FLO-NO-MO system opens only upon the actuation of the toilet tank flush handle without respect to the water level in the tank. The water supply valve closes automatically after passage of time requisite to fill the tank regardless of whether the tank held the water.

### CROSS-REFERENCE TO RELATED APPLICATIONS

The following application is incorporated herein by reference.

### Application Type: Provisional

Application number: 61/365,176

### Receipt Date: 19 Jul. 2010

### STATEMENT REGARDING FEDERALLY SPONSORED RESEARCH OR DEVELOPMENT

There was and is no federally sponsored research or development with respect to this invention.

### REFERENCE TO SEQUENCE LISTING, A TABLE, OR A COMPUTER PROGRAM LISTING COMPACT DISC APPENDIX

Not applicable.

### BACKGROUND OF THE INVENTION

The failure of toilet flappers to properly seal toilet tanks wastes a tremendous amount of water, often going undetected indefinitely. Water conservation is a critical global obligation. This invention controls the water supply to a toilet via an interconnect from the flush handle to a mechanical style water supply timer thereby preventing toilet systems from wasting water during an adverse system state.

### BRIEF SUMMARY OF THE INVENTION

Invention is a toilet water supply control system which integrates a mechanical style water supply timer at the point of water supply entry in a toilet tank with an actuation interconnect from the toilet flush handle to the mechanical style water supply timer. The timer is actuated by flushing the toilet thereby causing opening of the water supply valve for only the time requisite to fill the tank once. The timer will shunt the water supply upon attaining the time requisite to fill the tank regardless of system state thereby preventing supply water run-on normally associated with a system defect whether a system defect occurs during the flush/fill cycle or during any infinite time thereafter.

### BRIEF DESCRIPTION OF THE SEVERAL VIEWS OF THE DRAWING

FIG. 1 is an overview of the FLO-NO-MO system as installed in a common toilet tank.

FIG. 2 is an index to detail FIGS. 3 through 5.

FIG. 3 is a detail of the mechanical style water supply timer integration.

FIG. 4 is a detail of the crank attached to the mechanical style water supply timer.

FIG. 5 is a detail of the interconnect from the mechanical style water supply timer crank to the flush arm.

FIG. 6 is flush arm to timer crank handle interconnect material detail.

FIG. 7 is Crank Handle

FIG. 8 is Flush Assembly Front View

FIG. 9 is Flush Assembly Back View

FIG. 10 is Flush Handle Front View

FIG. 11 is Flush Handle Back View

FIG. 12 is Flush Handle Top View

FIG. 13 is Flush Handle Side View

FIG. 14 is Flush Handle Notes

FIG. 15 is Flush Arm Front View

FIG. 16 is Flush Arm Side View

FIG. 17 is Flush Assembly Threaded Sleeve

FIG. 18 is Flush Assembly Nut

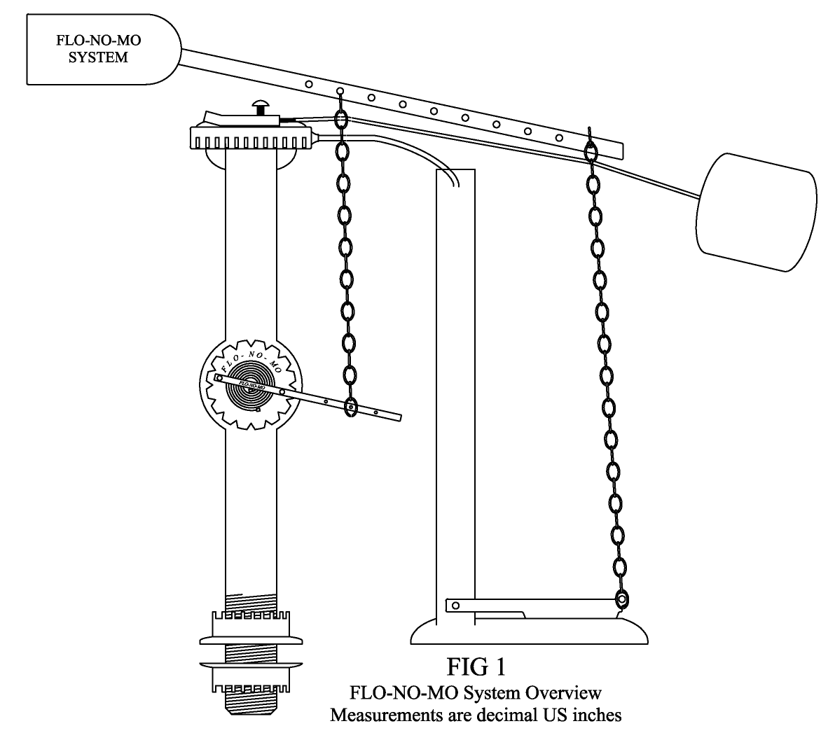

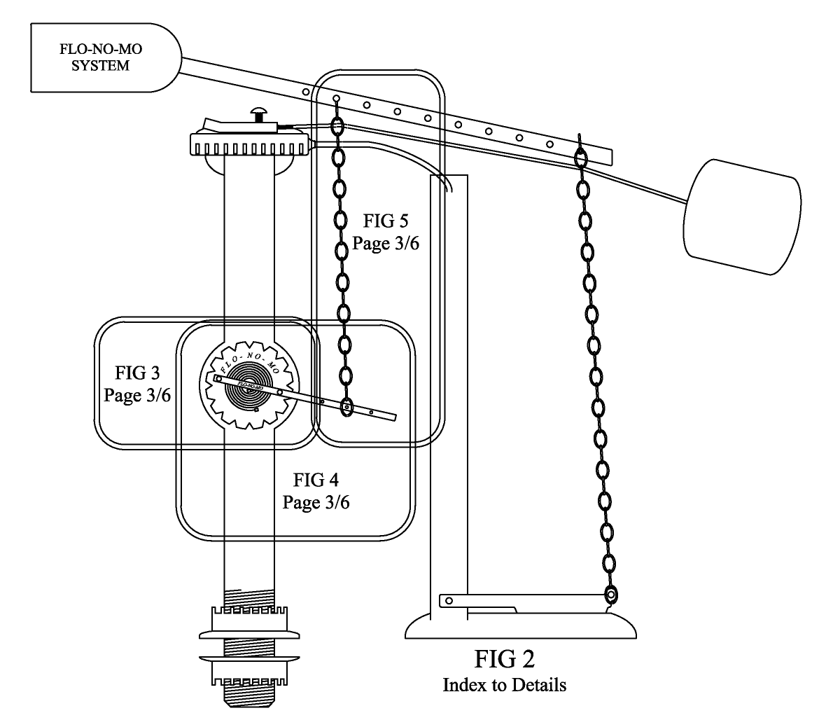

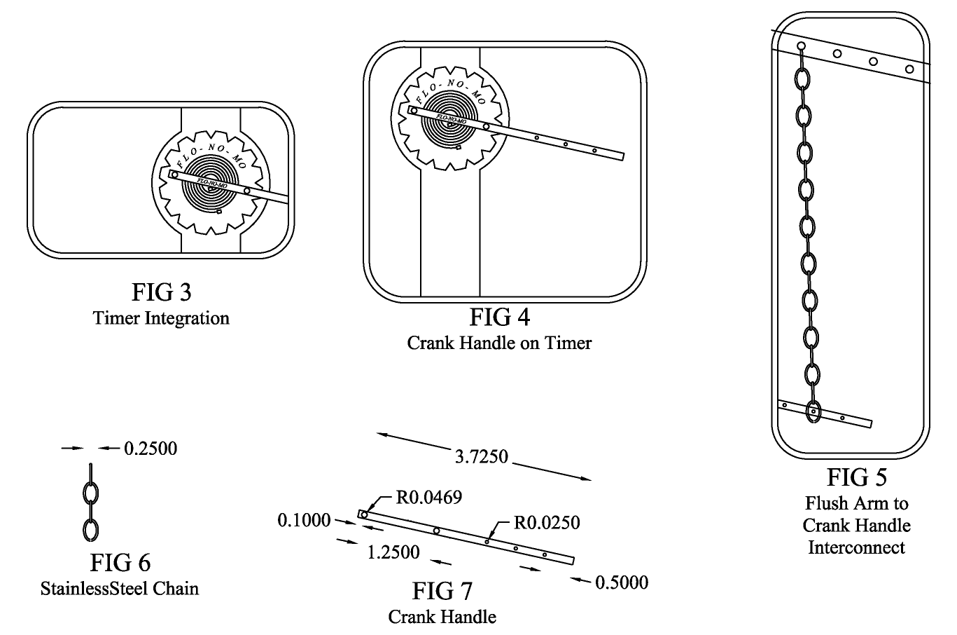

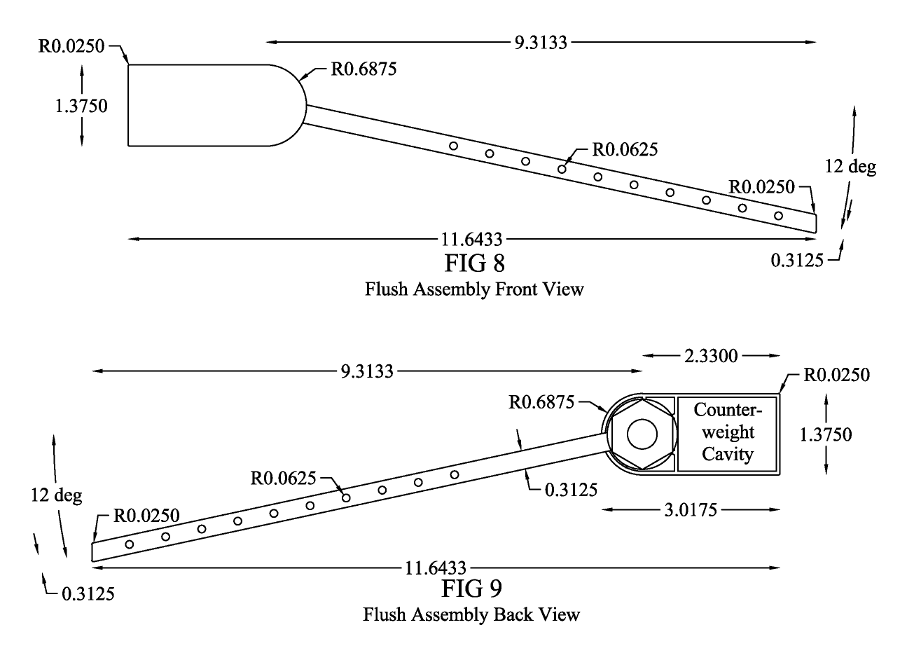

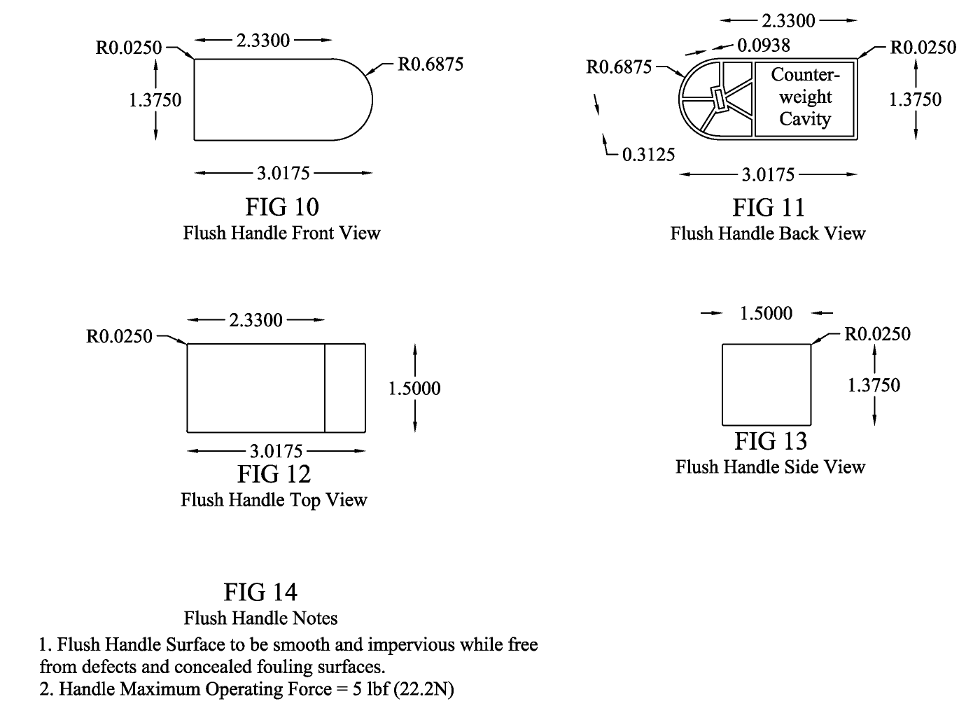

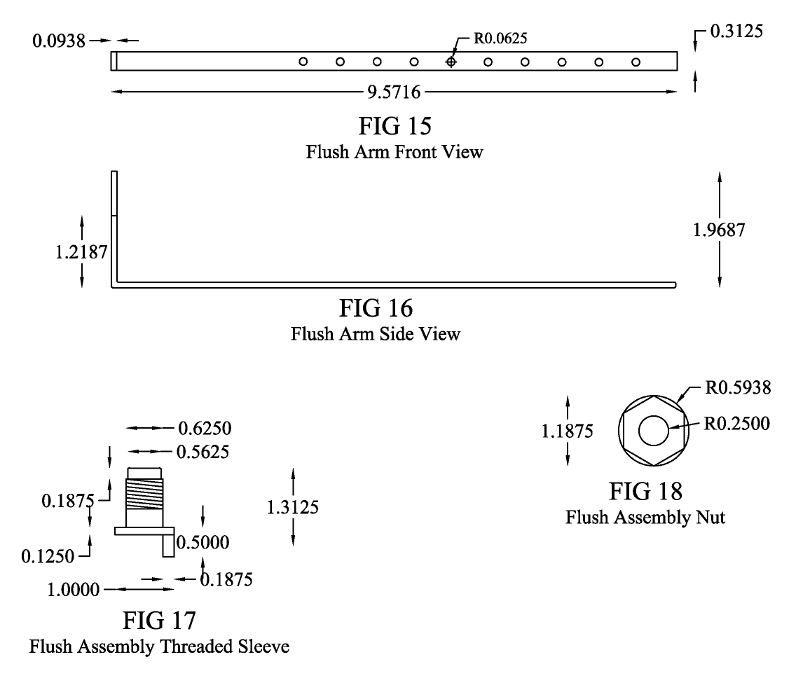

### DETAILED DESCRIPTION OF THE INVENTION

Invention is a toilet water supply control system which prevents failing toilet components from wasting water by controlling the water supply via a mechanical style timer, which upon flushing the toilet, only allows water to flow into the tank for the time requisite to fill the tank. Invention prevents wasting of water whether toilet system fails during the flush/fill cycle or during any infinite time thereafter. Only the action of flushing the toilet allows the mechanical style water supply timer to open the water supply valve for the time requisite to fill the tank.

Invention is made by integrating a mechanical style water supply timer into a conventional load control device in a toilet. A crank handle is attached to the mechanical style water supply timer and interconnected to the toilet flush assembly. The toilet flush assembly is custom made to provide for multiple interconnects while providing for a maximum operating force not exceeding five pounds force (22.2 Newtons) by utilizing offsetting counterweight.

Invention is made by installing a riser from the toilet water supply inlet to the inlet on a mechanical style water supply timer. Another riser extends from the outlet of the mechanical style water supply timer to the inlet of the conventional load control device in a toilet.

The crank handle is fabricated from a 3.275″ long piece of 0.3125″×0.0938″ extruded aluminum. It has two 0.0469″ radius mounting holes spaced 1.25″ apart beginning 0.1″ on center from the first end. It has three 0.025″ radius interconnect holes at 0.5″ spacing along the centerline beginning 0.5″ from the second end. It is attached to the mechanical style water supply timer and interconnected to the toilet flush assembly by a 0.25″ wide stainless steel chain.

The flush assembly consists of a flush handle, a flush arm, a flush assembly threaded sleeve, and a flush assembly nut.

The flush handle is 1.375″×3.0175″ overall, manufactured from cast aluminum, polished to a high sheen, and features a counterweight cavity accessible from the back. Mass is added to the counterweight cavity as necessary to calibrate the magnitude of force requisite to flush the toilet while concurrently activating the timer based on the force requisite to perform the sum of the operations which has been demonstrated to vary among different timers.

The flush arm is manufactured from a 11.5404 inches long piece of 0.3125″×0.0938″ extruded aluminum with 0.0625″ radius interconnect holes through the wide face thereof spaced 0.6250″ apart along the centerline commencing 0.6508″ inches from the terminus and concluding at the tenth hole.

The flush assembly threaded sleeve is manufactured from injection molded polyvinylchloride.

The flush assembly nut is manufactured from injection molded polyvinylchloride.

The flush assembly subassembly is made by pressing the flush handle under force a distance of 0.75″ into the flush arm, thence sliding the flush assembly threaded sleeve along the flush arm to the flush handle, and finally bending the flush arm ninety degrees at a point 9.5716 inches from the end thereof.

The final assembly of the flush assembly occurs at time of installation in a toilet tank by inserting the flush assembly subassembly through the industry standard hole in the tank wall, aligning the flush assembly threaded sleeve with the industry standard hole in the tank wall, sliding the flush assembly nut along the flush arm and securing the flush assembly nut to the flush assembly threaded sleeve.

Invention is used by flushing the toilet. Actuation of the toilet flush handle trips an interconnect to a mechanical style water supply timer which opens the water supply valve for only the time requisite to fill the tank. Upon passage of time requisite to fill the tank, the water supply closes and will not open again until a user subsequently actuates the flush handle. User is unaware of invention's presence and function under normal operating conditions.

If an adverse system state including but not limited to failure of the flapper to properly seal the tank arises during the flush/fill process, the system will prohibit supply water run-on by closing the water supply valve upon passage of time requisite to fill the tank regardless of whether any water was retained in the tank. A user will identify the system defect the next time they attempt to flush the toilet because when they activate the flush handle, the toilet will not flush, but water will again begin to flow into the toilet tank because of the interconnect from the flush handle to the water supply timer. This allows the water to enter the tank to allow the toilet to be flushed and informs the user to repair the system.

If an adverse system state arises during any infinite time after the flush/fill process has completed, the system will be protected from wasting water because only the actuation of the flush handle will allow supply water to enter the system. A user will identify the system defect the next time they attempt to flush the toilet because when they activate the flush handle, the toilet will not flush but water will begin to flow into the toilet tank because of the interconnect from the flush handle to the water supply timer. This allows the water to enter the tank to allow the toilet to be flushed and informs the user to repair the system.

Inventor contemplates:
1. Integrating the mechanical style water supply timer into the supply side of the conventional load control device as a single manufactured assembly.
2. Developing a function specific mechanical style water supply timer featuring:
   a. Minimum and maximum time periods best suited to the objective.
   b. A spring constant best suited to the objective.
   c. A consistent and lesser amount of force required to actuate the timer.
3. A crank universally adaptable to the various styles of systems.
4. Interconnects by means other than by using a conventional chain.
5. Adapting the invention to other liquid systems.

1. A system which automatically shunts the water supply to a tank-type toilet after passage of time requisite to fill the tank regardless of system state.

2. A system which protects the water consumption of a tank-type toilet if any system component fails during the flush/fill cycle or during any infinite time thereafter.

3. Integration of a mechanical style water supply timer into a conventional load control device in a tank-type toilet.

4. A means to routinely shunt the water supply to a tank-type toilet without human intervention whether the flapper or other system component fails during the flush/fill cycle or during any infinite time thereafter.

5. Attaching a crank to a mechanical style water supply timer.

6. Interconnecting the flush handle of a tank-type toilet to a redundant load control device.

7. Multiple connects to a tank-type toilet flush handle.

8. Custom made tank-type toilet flush handle with multiple interconnects and a counterweight system.
